(19) United States
(12) Patent Application Publication
(10) Pub. No.: US 2024/0006921 A1
(43) Pub. Date: Jan. 4, 2024

(54) POWER SUPPLY MAT, POWER SUPPLY VEHICLE, AND NONCONTACT POWER SUPPLY SYSTEM

(71) Applicant: TOYOTA JIDOSHA KABUSHIKI KAISHA, Toyota-shi (JP)

(72) Inventors: Daiki YOKOYAMA, Gotemba-shi (JP); Katsuya KOBAYASHI, Okazaki-shi (JP)

(73) Assignee: TOYOTA JIDOSHA KABUSHIKI KAISHA, Toyota-shi (JP)

(21) Appl. No.: 18/345,953

(22) Filed: Jun. 30, 2023

(30) Foreign Application Priority Data
Jul. 1, 2022 (JP) 2022-107190

(51) Int. Cl. H02J 50/12; B60L 55/00; H02J 50/40; B60L 58/12

(52) U.S. Cl. CPC H02J 50/12; B60L 55/00; H02J 50/402; B60L 58/12

(57) ABSTRACT

A power supply mat includes a connecting part to be electrically connected via a cable with a power supply vehicle having an external power supply function, a power transmission coil configured to transmit by noncontact the electric power supplied from the power supply vehicle through the connecting part to an outside power consuming device provided with a power reception coil, and a covering sheet configured to cover the power transmission coil.

### FIELD

The present disclosure relates to a power supply mat, power supply vehicle, and noncontact power supply system.

### BACKGROUND

Japanese Unexamined Patent Publication No. 2017-112806 discloses a disaster power supply system for dispatching a power supply vehicle having an external power supply function to an evacuation facility at the time of a power shortage due to a disaster and using the power supply vehicle to be able to supply power at the evacuation facility.

### SUMMARY

However, the number of electrical equipment and other power consuming devices which can be connected to a power supply vehicle depends on the number of power outlets provided at the power supply vehicle, so there is a limit to the number of power consuming devices which can be simultaneously supplied with outside power. Further, power consuming devices which cannot be connected to a power outlet of a power supply vehicle using a cable, in other words, power consuming devices which can only be supplied with power by noncontact, cannot be supplied with power from the power supply vehicle.

The present disclosure was made focusing on such a problem and has as its object to enable a plurality of power consuming devices to be supplied with power by noncontact so as to not be dependent on the number of power outlets provided at a power supply vehicle.

To solve the above problem, the power supply mat according to one aspect of the present disclosure comprises a connecting part configured to be electrically connected via a cable with a power supply vehicle having an external power supply function, a power transmission coil configured to transmit by noncontact the electric power supplied from the power supply vehicle through the connecting part to an outside power consuming device provided with a power reception coil, and a covering sheet configured to cover the power transmission coil.

Further, the power supply mat according to another aspect of the present disclosure is a power supply mat which has a power transmission coil covered by a covering sheet and which is configured to be able to receive power supply from a power supply vehicle having an external power supply function and to supply power by noncontact to an outside power consuming device arranged on the mat and provided with a power reception coil.

Further, the power supply vehicle having an external power supply function according to another aspect of the present disclosure is configured to supply power to the outside if electrically connected to a power supply mat with a transmission coil covered by a covering sheet and is configured to not supply power to the outside when a battery state of charge of the power supply vehicle is less than a predetermined state of charge.

Further, a noncontact power supply system according to still another aspect of the present disclosure comprises a power supply vehicle having an external power supply function, a power supply mat which is electrically connected via a cable with the power supply vehicle and which supplies power by noncontact to an outside power consuming device provided with a power reception coil, and a control device controlling the electric power supplied from the power supply vehicle to the power supply mat. The control device is configured to supply power by noncontact to the power consuming device if the power supply vehicle and power supply mat are electrically connected via the cable and is configured to not supply power to the power supply mat when a battery state of charge of the power supply vehicle is less than a predetermined state of charge.

According to these aspects of the present disclosure, by connecting a power supply vehicle and power supply mat, it is possible to use the power supply mat to supply power by noncontact to a plurality of power consuming devices without relying on the number of power outlets provided at the power supply vehicle.

### BRIEF DESCRIPTION OF DRAWINGS

FIG. 1 is a schematic perspective view of a noncontact power supply system according to one embodiment of the present disclosure.

FIG. 2 is a schematic view of the configuration of a control device according to one embodiment of the present disclosure.

FIG. 3 is an operation sequence diagram for explaining the content of part of the processing (computer programs) performed at a power supply vehicle and power supply mat for supplying power by noncontact to a power consuming device.

FIG. 4 is an operation sequence diagram for explaining the content of the processing (computer programs) performed at a power supply vehicle and power supply mat when a power supply start button has been pushed.

### DESCRIPTION OF EMBODIMENTS

Below, embodiments will be explained in detail while referring to the drawings. Note that, in the following explanation, similar component elements will be assigned the same reference notations.

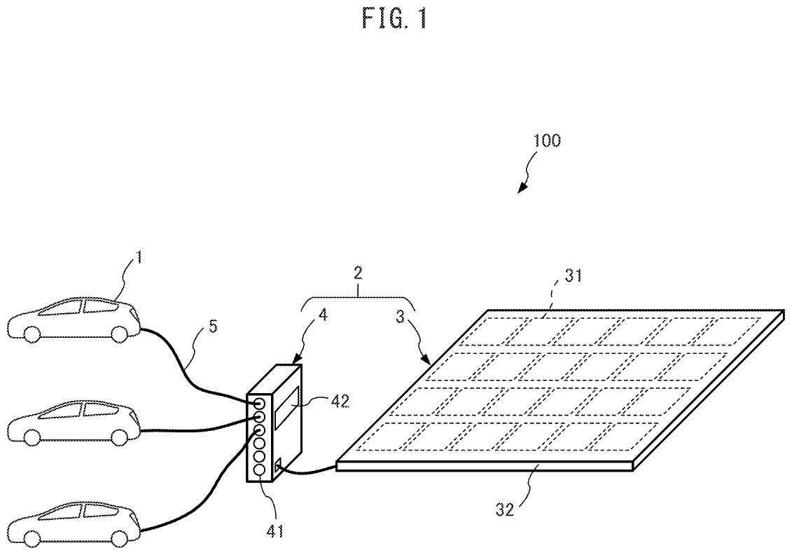

FIG. 1 is a schematic view of the configuration of a noncontact power supply system 100 according to one embodiment of the present disclosure.

The noncontact power supply system 100 is provided with power supply vehicles 1 and a power supply mat 2. Note that, in FIG. 1, to facilitate understanding of the disclosure, the power supply vehicles 1 and the power supply mat 2 are not shown by actual ratios of dimensions but are shown changing the ratios as needed so that the structures etc. become clear.

The power supply vehicles 1 are vehicles having external power supply functions enabling them to supply power to the outside. As the power supply vehicles 1, for example, battery electric vehicles (BEV) or hybrid electric vehicles (HEV), plug-in hybrid electric vehicles (PHEV), fuel cell electric vehicles (FCEV), etc. may be mentioned.

The power supply mat 2 is a mat which is configured to be electrically connected with the power supply vehicles 1 through cables 5 and to be able to transmit electric power supplied from the power supply vehicles 1 by noncontact to power consuming devices designed for noncontact power supply (that is, power consuming devices having power reception coils) and is provided with a mat part 3 and a coupling device 4. The power supply mat, as shown in FIG. 1, can be arranged on the ground or on a floor surface. In addition, for example, it can be arranged on a wall surface. The power consuming devices are not particularly limited and may be communication devices or household appliances or may be vehicles or micropallets or other moving bodies. Below, continuing to view FIG. 1, details of the mat part 3 and coupling device 4 which the power supply mat 2 is provided with will be explained.

The mat part 3 is provided with power transmission coils 31 and a covering sheet 32.

The power transmission coils 31 transmit power by noncontact by, for example, magnetic resonant coupling (magnetic field resonance) to power consuming devices arranged on the mat part 3. Note that the power transmission method is not limited to magnetic resonant coupling (magnetic field resonance) and may also be magnetic field coupling (electromagnetic induction), electric field coupling, electric resonant coupling (electric field resonance), or other power transmission methods.

The covering sheet 32 is a sheet-shaped member for covering the power transmission coils 31 and has the function of protecting the power transmission coils 31. In the present embodiment, the covering sheet 32 is configured by a member having flexibility so as to enable the mat part 3 to, for example, be wound up in a roll shape or be folded. Due to this, the power supply mat 2 can be easily stored or transported.

The coupling device 4 is provided with a plurality of cable connection terminals 41 for coupling the power supply mat 2 to a plurality of power supply vehicles 1 and a control device 42 for comprehensively controlling the overall operation of the power supply mat 2.

The cable connection terminals 41 are terminals for connecting with one ends of cables connected at other ends to power outlets of the power supply vehicles 1. Note that the coupling device 4 is provided inside it with a power transmission circuit (not shown) for supplying to the power transmission coils 31 the electric power of the power supply vehicles 1 supplied through the cable connection terminals 41. Using the power transmission circuit, the electric power of the power supply vehicles 1 is suitably supplied to the power transmission coils 31 so that the power transmission coils and the power reception coils of the power consuming devices arranged spaced apart are magnetically coupled and power is transmitted by noncontact.

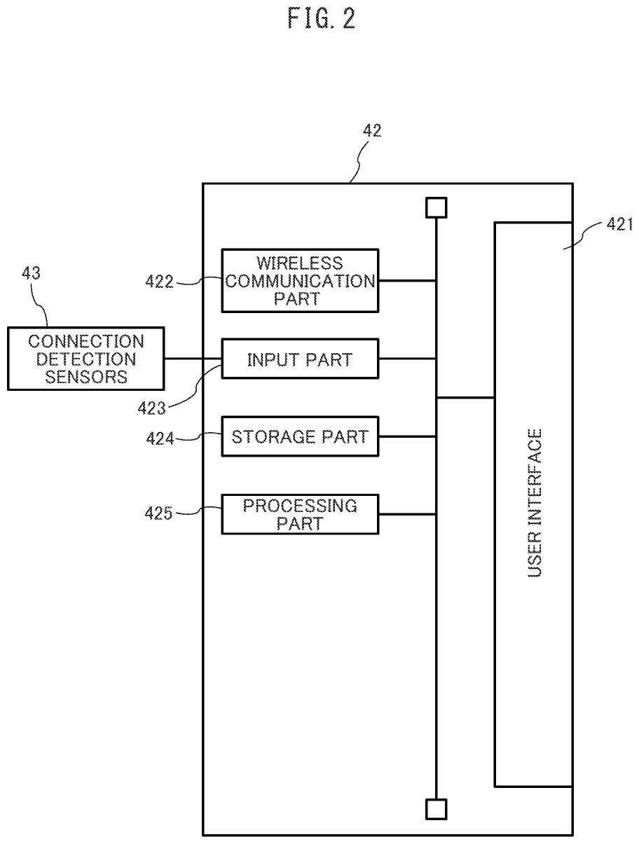

FIG. 2 is a schematic view of the configuration of the control device 42. As shown in FIG. 2, the control device 42 is provided with a user interface 421, wireless communication part 422, input part 423, storage part 424, and processing part 425.

The user interface 421 is, for example, a touch panel display. The user interface 421 generates signals corresponding to various types of operations by a user (person using power supply mat 2) and outputs the signals to the processing part 425. Further, the user interface 421 displays various types of display use information received from the processing part 425.

The wireless communication part 422 is provided with an antenna and a signal processing circuit for performing various types of processing relating to wireless communication such as modulation and demodulation of a wireless signal. The wireless communication part 422 performs wireless communication with the power supply vehicles 1 connected through the cables 5. Further, the wireless communication part 422 wirelessly communicates with the power consuming devices placed on the mat part 3.

The input part 423 receives as input the output signals from the various types of sensors receiving information required when controlling the operation of the power supply mat 2 etc. In the present embodiment, the input part 423 receives as input the output signals of connection detection sensors 43 for detecting the connection of cables 5 to the cable connection terminals 41 etc.

The storage part 424 has an HDD (hard disk drive) or SSD (solid state drive), optical recording medium, semiconductor memory, or other storage medium and stores the various types of computer programs or data etc. used for processing at the processing part 425.

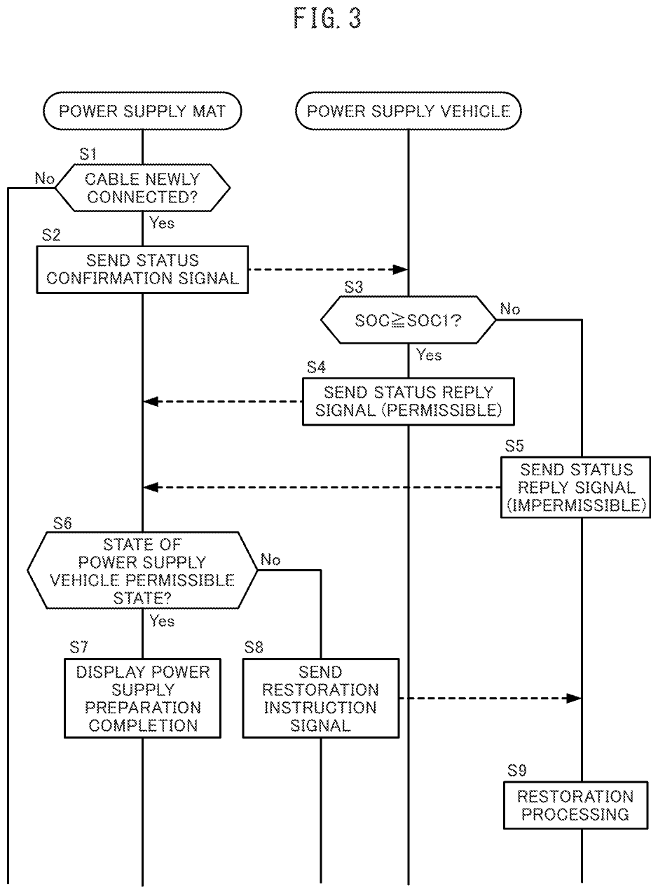

The processing part 425 is provided with a processor having one or more CPUs (central processing units) and their peripheral circuits. The processing part 425 performs various types of processing based on various types of computer programs stored in the storage part 424. Below, referring to FIG. 3, the various types of processing performed at the processing part 425 and in turn the power supply mat 2 will be explained.

FIG. 3 is an operation sequence diagram explaining the content of part of the processing (computer programs) performed at a power supply vehicle 1 and the power supply mat 2 for supplying power by noncontact to a power consuming device. Note that the present processing is performed by the power supply vehicle 1, more specifically a control device (not shown) mounted in the power supply vehicle 1, and is performed by the power supply mat 2, more specifically the processing part 425 of the control device 42.

At step S1, the power supply mat 2 judges whether a cable 5 has been newly connected to a cable connection terminal 41 based on an output signal of a connection detection sensor 43. If a cable 5 has been newly connected to a cable connection terminal 41, the power supply mat proceeds to the processing of step S2. On the other hand, if a cable 5 has not been newly connected to a cable connection terminal 41, the power supply mat 2 ends the current processing.

At step S2, the power supply mat 2 establishes communication with the power supply vehicle 1 newly connected via a cable 5 and sends a status confirmation signal to that power supply vehicle 1 for confirming whether the state at the power supply vehicle side is a state enabling supply of power to the power supply mat 2 to be permitted.

At step S3, if receiving the status confirmation signal from the power supply mat 2 through a wireless communication device (not shown) mounted in its host vehicle, the power supply vehicle 1 judges whether the state of its host vehicle is a state enabling power supply to the power supply mat 2 to be permitted. In the present embodiment, if the state of charge SOC of the battery (below, referred to as the “battery state of charge”) mounted in the host vehicle is greater than or equal to a predetermined threshold value SOC1 the power supply vehicle 1 judges that the state of the host vehicle is a “power supply permissible state” enabling power supply to the power supply mat 2 to be permitted and proceeds to the processing of step S4. On the other hand, if the battery state of charge SOC is less than the threshold value SOC1, the power supply vehicle 1 judges that the state of the host vehicle is a “power supply impermissible state” not enabling power supply to the power supply mat 2 to be permitted and proceeds to the processing of step S5.

At step S4 and step S5, the power supply vehicle 1 sends the power supply mat 2 a status reply signal through a wireless communication device (not shown) mounted in the host vehicle. In the present embodiment, the status reply signal includes the state of the host vehicle and the current battery state of charge SOC of the host vehicle. The status reply signal sent at step S4 becomes a signal notifying the power supply mat 2 that the state of the host vehicle is a “power supply permissible state” while the status reply signal sent at step S5 becomes a signal notifying the power supply mat 2 that the state of the host vehicle is a “power supply impermissible state”.

At step S6, if as a result of reception of the status reply signal, the state of the power supply vehicle 1 is a “power supply permissible state”, the power supply mat 2 proceeds to the processing of step S7, while if it is a “power supply impermissible state”, the power supply mat 2 proceeds to the processing of step S8.

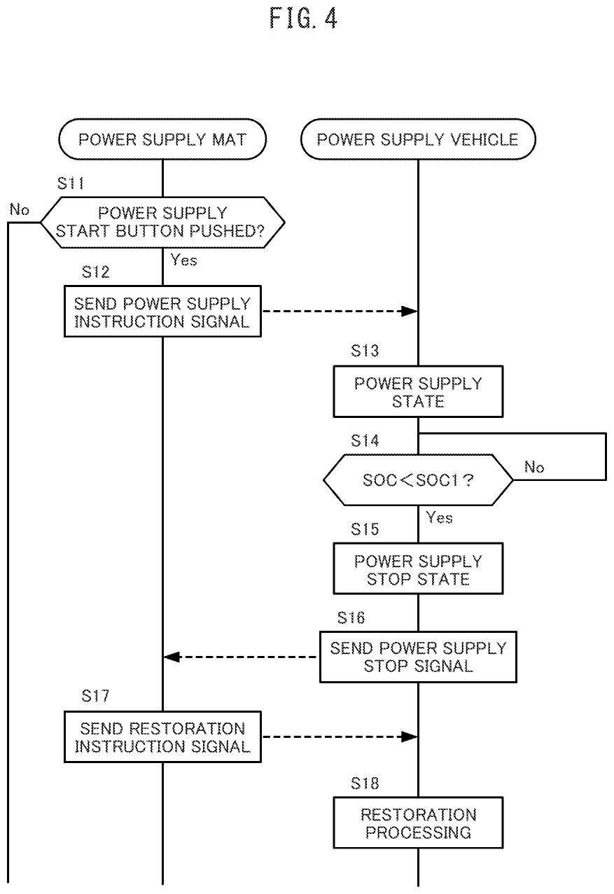

At step S7, the power supply mat 2 displays to the user interface 421 the fact that preparations for power supply have been completed and displays a power supply start button. If the power supply start button is pushed, the power supply mat 2 requests the power supply vehicle 1 to supply power and starts noncontact transmission of power to the power consuming device placed on the mat part 3. The processing after the power supply start button has been pushed will be explained later with reference to FIG. 4. Note that the processing of this step S7 may also be omitted. Therefore, it is also possible to automatically start noncontact power transmission to the power consuming device placed on the mat part 3 if, as a result of receiving the status reply signal, the state of the power supply vehicle 1 was the “power supply permissible state”.

At step S8, the power supply mat 2 sends a restoration instruction signal for prompting the power supply vehicle 1 which has sent a status reply signal to the effect of the state of the host vehicle being a “power supply impermissible state” to perform restoration processing for raising the battery state of charge SOC to a predetermined state of charge.

At step S9, if receiving a restoration instruction signal, the power supply vehicle 1 performs restoration processing. The restoration processing is, if for example the power supply vehicle 1 is a hybrid vehicle or a plug-in hybrid vehicle, processing for driving the engine mounted on the power supply vehicle 1 so as to charge the battery. Further, if the power supply vehicle 1 is a fuel cell vehicle, it is processing for generating power by the fuel cell mounted in the power supply vehicle 1 so as to charge the battery. Further, if the power supply vehicle 1 is an electric vehicle, it is processing for notifying the user that the battery has to be charged. Note that if the restoration processing ends, the power supply vehicle 1 resends the power supply mat 2 a status reply signal including the fact that the state of the host vehicle is a “power supply permissible state” and the restored battery state of charge SOC of the host vehicle.

FIG. 4 is an operation sequence diagram for explaining the content of processing (computer programs) performed at the power supply vehicle 1 and the power supply mat 2 if the power supply start button has been pushed. Note that the present processing is performed at the power supply vehicle 1, more specifically at a control device (not shown) mounted in the power supply vehicle 1, and is performed at the power supply mat 2, more specifically at the processing part 425 of the control device 42.

At step S11, the power supply mat 2 judges whether the power supply start button has been pushed. If the power supply start button has been pushed, the power supply mat 2 proceeds to the processing of step S12. On the other hand, if the power supply start button has not been pushed, the power supply mat 2 ends the current processing.

At step S12, the power supply mat 2 sends the power supply vehicle 1 a power supply instruction signal. Note that in the present embodiment, if there is a single power supply vehicle 1 connected to the power supply mat 2, the power supply mat 2 sends the power supply vehicle 1 a power supply instruction signal, while if there are a plurality of power supply vehicles 1 connected to the power supply mat 2, it determines the priority order for sending the power supply instruction signal among them and sends the power supply vehicle 1 with the highest priority order a power supply instruction signal.

The method of determination of the priority order is not particularly limited but, for example, it can be determined based on the battery states of charge SOC of the power supply vehicles 1. In the present embodiment, the higher the battery state of charge SOC of a power supply vehicle 1 among the power supply vehicles 1, the higher the priority order is made. The power supply vehicle 1 with the highest battery state of charge SOC among the power supply vehicles 1 is sent the power supply instruction signal. Further, for example, if the status reply signal contains the scheduled running information of the power supply vehicle 1, it can be determined based on the scheduled running information of the power supply vehicles 1. In this case, for example, the more leeway until the scheduled running point of time of a power supply vehicle 1 among the power supply vehicles 1, the higher the priority order can be made. Further, the shorter the scheduled running distance of a power supply vehicle 1, the higher the priority order can be made.

At step S13, if receiving the power supply instruction signal, the power supply vehicle 1 renders the host vehicle a power supply state able to supply power to a power consuming device placed on the mat part 3.

At step S14, the power supply vehicle 1 judges whether the battery state of charge SOC is less than the threshold value SOC1. If the battery state of charge is less than the threshold value SOC1, the power supply vehicle 1 proceeds to the processing of step S15. On the other hand, if the battery state of charge is greater than or equal to the threshold value SOC1, the power supply vehicle 1 again performs the processing of step S14 after a predetermined time period elapses.

At step S15, the power supply vehicle 1 renders the host vehicle a power supply stop state for stopping once the supply of power to the power consuming device placed on the mat part 3.

At step S16, the power supply vehicle 1 sends a power supply stop signal providing notification that the state of the host vehicle has changed from a “power supply permissible state” to a “power supply impermissible state”.

At step S17, if receiving the power supply stop signal, the power supply mat 2 sends a restoration instruction signal to the power supply vehicle 1 originating that signal. At this time, if there is a single power supply vehicle 1 connected to the power supply mat 2, the power supply mat 2 notifies the user of the power supply mat 2 through the user interface 421 that the power supply vehicle 1 is being charged and power supply is temporarily being stopped until charging is completed. Alternatively, if there are several power supply vehicles 1 connected to the power supply mat 2, the power supply mat 2 sends a power supply instruction signal to another power supply vehicle 1 with the highest priority order among them and receives power supply from that other power supply vehicle 1 to supply power by noncontact to the power consuming device placed on the mat part 3.

At step S18, if receiving a restoration instruction signal, the power supply vehicle 1 performs restoration processing. Note that if the restoration processing ends, the power supply vehicle 1 resends the power supply mat 2 a status reply signal including the fact that the state of the host vehicle is a “power supply permissible state” and the restored battery state of charge SOC of the host vehicle.

The power supply mat 2 according to the present embodiment explained above is provided with a coupling device 4 (connecting part) which is electrically connected via cables 5 to power supply vehicles 1 having an external power supply function, power transmission coils 31 for transmitting by noncontact power supplied from the power supply vehicles 1 through the coupling device 4 to outside power consuming devices provided with power reception coils, and a covering sheet 32 for covering the power transmission coils 31.

By configuring the power supply mat 2 in this way, it is possible to utilize power supply vehicles 1 to supply power by noncontact to a plurality of power consuming devices placed on the power supply mat 2 without regard as to the number of power outlets provided at the power supply vehicles 1. For this reason, for example, it is possible to keep power from becoming short at evacuation facilities etc. at the time of disasters.

Further, in the present embodiment, the coupling device 4 (connecting part) of the power supply mat 2 is configured to be able to connect with a plurality of power supply vehicles 1. More specifically, the power supply mat 2 is further provided with a control device 42 for controlling the electric power supplied from the power supply vehicles 1 to the power supply mat 2. The control device 42 is configured to switch a power consuming device from one power supply vehicle 1 to another power supply vehicle 1 in the plurality of power supply vehicles 1 if receiving the supply of power from one power supply vehicle 1 among the plurality of power supply vehicles 1 and the battery state of charge SOC of that one power supply vehicle 1 becomes less than a predetermined state of charge SOC1.

For this reason, even if the battery state of charge SOC of one power supply vehicle 1 has fallen, the supply of power can be received from another power supply vehicle 1, so power can continue to be supplied by noncontact.

Further, the control device 42 of the power supply mat 2 according to the present embodiment is configured to not supply power from the power supply vehicle 1 when the battery state of charge SOC of the power supply vehicle 1 is less than a predetermined state of charge SOC1. In other words, the power supply vehicle 1 according to the present embodiment is configured to supply power to the outside if electrically connected to the power supply mat 2 with power transmission coils covered by the covering sheet 32 and is configured to not supply power to the outside even if it is electrically connected to the power supply mat 2 when the battery state of charge SOC is less than a predetermined state of charge SOC1.

For this reason, it is possible to keep the battery state of charge SOC of a power supply vehicle 1 from falling too much, so it is possible to keep subsequent use of the power supply vehicle 1 from being impeded or the battery from deteriorating.

Further, the control device 42 of the power supply mat 2 according to the present embodiment is configured so as to instruct a power supply vehicle 1 to perform restoration processing for raising the battery state of charge SOC when the battery state of charge SOC of the power supply vehicle 1 is less than a predetermined state of charge SOC1. In other words, the power supply vehicle 1 according to the present embodiment is configured so as to perform restoration processing for raising the battery state of charge SOC when it is electrically connected to the power supply mat 2 if the battery state of charge SOC is less than a predetermined state of charge SOC1.

For this reason, even if the battery state of charge SOC of a power supply vehicle 1 has fallen, it is possible to restore the battery state of charge SOC and continuously supply power by noncontact. Further, it is also possible to keep subsequent use of the power supply vehicle 1 from being obstructed.

Further, the noncontact power supply system 100 according to the present embodiment is provided with power supply vehicles 1 having external power supply functions, a power supply mat 2 electrically connected to the power supply vehicles 1 via the cables 5 and supplying power by noncontact to outside power consuming devices provided with power reception coils, and a control device 42 controlling the electric power supplied from the power supply vehicles 1 to the power supply mat 2.

Further, the control device 42 is configured to supply power to the power supply mat 2 when a power supply vehicle 1 and the power supply mat 2 are electrically connected via a cable 5 and is configured to not supply power to the power supply mat 2 even when the power supply vehicle 1 and the power supply mat 2 are electrically connected if the battery state of charge SOC of the power supply vehicle 1 is less than the predetermined state of charge SOC1. Further, the control device 42 is configured so as to perform restoration processing for raising the battery state of charge SOC of a power supply vehicle 1 when the power supply vehicle 1 and the power supply mat 2 are electrically connected via a cable 5 if the battery state of charge SOC of the power supply vehicle 1 is less than a predetermined state of charge SOC1.

Note that in the present embodiment, the electric power supplied from the power supply vehicles 1 to the power supply mat 2 is controlled by the control device 42 of the power supply mat 2, but the disclosure is not limited to this. It may also be controlled by the control devices mounted in the power supply vehicles 1. That is, the control devices mounted in the power supply vehicles 1 may be configured to supply power to the power supply mat 2 when the power supply vehicles 1 and the power supply mat 2 are electrically connected through the cables 5 and configured to not supply power to the power supply mat 2 even when the power supply vehicles 1 and the power supply mat 2 are electrically connected if the battery state of charge SOC of the power supply vehicles 1 is less than a predetermined state of charge SOC1.

Above, embodiments of the present disclosure were explained, but the above embodiments only show some of the examples of application of the present disclosure and are not meant to limit the technical scope of the present disclosure to the specific constitutions of the embodiments.

For example, in the above embodiments, when supplying power by noncontact to the power consuming devices, the power consuming devices and the power supply mat 2 may wirelessly communicate to send requests of amounts of power of the power consuming devices to the power supply mat 2 and supply power corresponding to the requests of amounts of power from the power supply vehicles through the power supply mat to the power consuming devices.

Further, in the above embodiments, the power supply vehicles 1 and the power supply mat 2 communicated wirelessly, but the cables 5 may also be given the functions of wired communications and the cables 5 used for communication between the power supply vehicles 1 and the power supply mat 2.

Further, in the above embodiments, in a case where a plurality of power supply vehicles 1 are connected to the power supply mat 2, a priority order was established for receiving power from one vehicle at a time, but it is also possible to receive power simultaneously from a plurality of power supply vehicles 1.

1. A power supply mat comprising:
a connecting part configured to be electrically connected via a cable with a power supply vehicle having an external power supply function;
a power transmission coil configured to transmit by noncontact the electric power supplied from the power supply vehicle through the connecting part to an outside power consuming device provided with a power reception coil; and
a covering sheet configured to cover the power transmission coil.

2. The power supply mat according to claim 1, wherein
the connecting part is configured to be able to connect with a plurality of power supply vehicles.

3. The power supply mat according to claim 1,
further comprising a control device configured to control the electric power supplied from a power supply vehicle to the power supply mat,
the control device configured to not receive the supply of power from a power supply vehicle when a battery state of charge of the power supply vehicle is less than a predetermined state of charge.

4. The power supply mat according to claim 1,
further comprising a control device configured to control the electric power supplied from a power supply vehicle to the power supply mat,
the control device configured to instruct the power supply vehicle to perform restoration processing for raising a battery state of charge when the battery state of charge of the power supply vehicle is less than a predetermined state of charge.

5. The power supply mat according to claim 2,
further comprising a control device configured to control the electric power supplied from a power supply vehicle to the power supply mat,
the control device configured to switch a source of the supply of power from one power supply vehicle among the plurality of power supply vehicles to another power supply vehicle among the plurality of power supply vehicles when receiving the supply of power from one power supply vehicle and a battery state of charge of that one power supply vehicle becomes less than a predetermined state of charge.

6. A power supply mat which has a power transmission coil covered by a covering sheet, wherein
the power supply mat is configured to be able to receive power supply from a power supply vehicle having an external power supply function and to supply power by noncontact to an outside power consuming device arranged on the mat and provided with a power reception coil.

7. A power supply vehicle having an external power supply function, wherein
the power supply vehicle is configured to supply power to the outside if electrically connected to a power supply mat with a transmission coil covered by a covering sheet and is configured to not supply power to the outside when a battery state of charge of the power supply vehicle is less than a predetermined state of charge even if electrically connected to the power supply mat.

8. The power supply vehicle according to claim 7, wherein
the power supply vehicle is configured to perform restoration processing for raising a battery state of charge when electrically connected to the power supply mat if the battery state of charge of the power supply vehicle is less than a predetermined state of charge.

9. A power supply system comprising:
a power supply vehicle having an external power supply function,
a power supply mat configured to be electrically connected via a cable with the power supply vehicle and supply power by noncontact to an outside power consuming device provided with a power reception coil, and
a control device configured to control the electric power supplied from the power supply vehicle to the power supply mat, wherein
the control device is configured to supply power by noncontact to the power consuming device if the power supply vehicle and power supply mat are electrically connected via the cable and is configured to not supply power to the power supply mat even if the power supply vehicle and power supply mat are electrically connected when a battery state of charge of the power supply vehicle is less than a predetermined state of charge.

10. The power supply system according to claim 9, wherein
the control device is configured to perform restoration processing for raising a battery state of charge when the power supply vehicle and the power supply mat are electrically connected through the cable if the battery state of charge of the power supply vehicle is less than a predetermined state of charge.
